(19) United States
(12) Patent Application Publication
(10) Pub. No.: US 2026/0287186 A1
(43) Pub. Date: Sep. 24, 2026

(54) HEAT SUPPLIER

(71) Applicant: LG ELECTRONICS INC., Seoul (KR)

(72) Inventors: Kiyoon PARK, Seoul (KR); ILHAN YUN, Seoul (KR); Jonghae LEE, Seoul (KR); Taeho KONG, Seoul (KR); Gwansoo LEE, Seoul (KR); Jungyoon KIM, Seoul (KR); Dongmin SEO, Seoul (KR); Changgeun HAN, Seoul (KR)

(73) Assignee: LG ELECTRONICS INC., Seoul (KR)

(21) Appl. No.: 19/571,061

(22) Filed: Mar. 18, 2026

(30) Foreign Application Priority Data
Mar. 18, 2025 (KR) 10-2025-0034633

(51) Int. Cl. F24F 5/00; F24F 13/20; F24F 13/30; F28F 13/06

(52) U.S. Cl. CPC F24F 5/0003; F24F 13/20; F24F 13/30; F28F 13/06; F28F 2250/08; F28F 2250/102

(57) ABSTRACT

A heat supplier includes a case. The case includes a front cover including an inlet, a rear cover including an outlet, and a side plate covering a side hole located between the front cover and the rear cover. Additionally, the heat supplier also includes a second heat exchanger disposed inside the case and configured to exchange heat between refrigerant and a heat medium, the second heat exchanger being exposed to an outside when the side hole is opened, and a control box disposed inside the case, the control box being exposed to the outside when the side hole is opened.

### CROSS-REFERENCE TO RELATED APPLICATIONS

This application claims priority to Korean Patent Application No. 10-2025-0034633 filed on Mar. 18, 2025, in the Korean Intellectual Property Office, the entire contents of which are hereby expressly incorporated by reference into the present application.

### BACKGROUND

### 1. Field of the invention

The present disclosure relates to a heat supplier, and more particularly to an air water heat pump (AWHP) that supplies a heat medium heat-exchanged to an indoor space.

### 2. Description of the Related Art

Recent environmental regulations and energy efficiency requirements have led to the proliferation of air water heat pump (AWHP) systems.

As a result, a plate-type heat exchanger for refrigerant-water heat exchange is essentially disposed inside an outdoor unit.

The plate-type heat exchanger is a component in which a refrigerant and water directly exchange heat, and is highly susceptible to performance deterioration due to factors such as water flow variations, contamination, and scale formation.

In particular, problems such as clogging or corrosion may occur during long-term use, so regular inspection and cleaning are required. Moreover, a difficulty of maintenance varies depending on a coupling structure with a water circulation system, and this is pointed out as a problem in that a frequent service is required.

Therefore, design of a more efficient and maintenance-friendly AWHP system is required.

Korean Patent Unexamined Publication No. KR 10-2025-0015213 A also discloses a configuration for a heat supplier, but does not disclose contents regarding the arrangement of specific configurations for service improvement.

### SUMMARY OF THE DISCLOSURE

In view of the above, an object of the present disclosure is to solve the above-described problems and other problems.

Another object is to provide a heat supplier that allows easy confirmation and inspection of components requiring a frequent service by removing only side plates.

Yet another object is to provide a heat supplier that simplifies a configuration of pipes through which a heat medium connected in a plate-type heat exchanger flow and simplifies the arrangement.

Still yet another is to provide a heat supplier that ensures a space between a pump device and the heat exchanger, and a space between the pump device and a heat medium pipe to the maximum.

In order to achieve the object, a heat supplier according to an embodiment includes a case including a front cover in which an inlet is formed, a rear cover in which an outlet is formed, and a side plate covering a side hole formed on one side of each of the front cover and the rear cover.

The heat supplier includes a second heat exchanger disposed inside the case and exchanging heat between refrigerant and a heat medium, and a control box disposed inside the case and having a plurality of electrical components disposed therein.

When the side hole is opened, the second heat exchanger and the control box are exposed to the outside.

The control box is disposed above the second heat exchanger.

The heat supplier includes a pump device disposed inside the case and supplying the heat medium to the second heat exchanger. When the side hole is opened, the pump device is exposed to the outside.

The pump device includes the pump housing, an impeller rotatably disposed inside the pump housing, a pump motor rotating the impeller, and a motor shaft connecting the pump motor and the impeller. A slot rotating the motor shaft is formed on one side of the pump housing. When the side hole is opened, the slot is exposed to the outside.

The pump housing includes a first housing in which the pump motor is disposed, and a second housing in which the impeller is disposed. The first housing and the second housing are fastened to each other by a bolt. When the side hole is opened, the bolt is exposed to the outside.

The pump device is disposed spaced apart forward from the second heat exchanger.

The second heat exchanger includes a front plate in which a plurality of ports are disposed, through which a refrigerant pipe and a heat medium pipe are connected. The pump device is disposed spaced apart forward from the front plate.

The second heat exchanger includes a front plate on which a refrigerant pipe port to which the refrigerant pipe is connected and a heat medium pipe port to which the heat medium pipe is connected are disposed. The refrigerant pipe port is disposed closer to the side hole than the heat medium pipe port.

The refrigerant pipe is formed to have a smaller diameter than the heat medium pipe.

The heat supplier includes a heat medium pipe connected to the second heat exchanger, through which the heat medium flows. The heat medium pipe is constituted by a plurality of pipe bundles manufactured by injection molding from the same material. Each of the plurality of pipe bundles is formed in a structure in which its ends are coupled to each other.

The heat supplier includes a first heat medium pipe connected to the second heat exchanger and supplying the heat medium to the second heat exchanger, and a second heat medium pipe connected to the second heat exchanger and discharging the heat medium from the second heat exchanger. The first heat medium pipe is disposed below the second heat medium pipe. The pump device is disposed in the first heat medium pipe.

The pump device is disposed spaced apart forward from the second heat exchanger. The second heat medium pipe is disposed spaced apart upward from the pump device. A distance at which the second heat medium pipe is spaced upward from the pump device is formed to be larger than a distance at which the pump device is spaced forward from the second heat exchanger.

The first heat medium pipe and the second heat medium pipe each include a straight pipe bundle extending in a straight direction and a curved pipe bundle extending in a curved direction. The curved pipe bundle changes a flow direction of the heat medium to an opposite direction.

A sensor is disposed in the straight pipe bundle, which senses a temperature or pressure of the heat medium flowing through the first heat medium pipe or the second heat medium pipe.

The first heat medium pipe includes a first straight pipe bundle extending in the straight direction and a first curved pipe bundle extending in the curved direction. The second heat medium pipe includes a second straight pipe bundle extending in the straight direction and a second curved pipe bundle extending in the curved direction.

The first curved pipe bundle and the second curved pipe bundle is each disposed to be inclined downward. An inclination angle of the first curved pipe bundle is formed to be greater than an inclination angle of the second curved pipe bundle.

A left-right width of the second heat exchanger is formed to be equal to or less than 1/3 of a left-right width of the case.

The heat supplier includes a tank disposed inside the case and storing a portion of the heat medium flowing through the second heat exchanger, and a connection port disposed on one side of the case and connected to a heat medium pipe extending from the second heat exchanger. The second heat exchanger is disposed closer to the side hole than the tank. The connection port is disposed between the tank and the second heat exchanger.

The heat supplier includes a compressor compressing refrigerant, and sending the compressed refrigerant to a first heat exchanger which exchanges heat with the compressed refrigerant with air or the second heat exchanger. The compressor is disposed in an opposite direction to the second heat exchanger based on the tank.

The front cover includes a first front cover in which the inlet is formed, and a second front cover disposed on one side of the first front cover and disposed removably from the first front cover. When the second front cover is separated from the first front cover, the compressor is exposed to the outside.

When the side hole is opened, the electrical component disposed in the control box is exposed to the outside.

Details of other embodiments will be included in the detailed description and the accompanying drawings.

According to a heat supplier according to the present disclosure, there are one or more following effects.

First, a second heat exchanger and a pump device can be confirmed and inspected through a structure in which the second heat exchanger and the pump device are spaced apart in a structure with a side hole is opened. Further, a control box is disposed above the second heat exchanger, so that an inside of the control box can also be serviced.

Second, by simplifying a configuration of a heat medium pipe and adjusting the arrangement, it is possible to confirm and inspect a plurality of sensors disposed in the heat medium pipe. Further, service can also be performed on a tank disposed next thereto.

Third, by securing a space between the pump device and the heat exchanger, it is possible to improve a work speed of a worker performing service.

Fourth, in the case of a compressor, the tank can cover the compressor so that it is not easily accessible from the outside, and the service can be performed by removing a separate front cover. The effects of the present disclosure are not limited to the aforementioned effect, and other effects, which are not mentioned above, will be apparent to a person having ordinary skill in the art from the description of the claims.

### BRIEF DESCRIPTION OF THE DRAWINGS

FIG. 1 is a schematic view for describing a configuration of a heat supplier according to an embodiment of the present disclosure.

FIG. 2 is a perspective view of one side of the heat supplier according to an embodiment of the present disclosure.

FIG. 3 is a perspective view of the other side of the heat supplier according to an embodiment of the present disclosure.

FIG. 4 is a side view of the heat supplier according to an embodiment of the present disclosure.

FIG. 5 is a perspective view of one side for describing a second heat exchanger and components related thereto according to an embodiment of the present disclosure.

FIG. 6 is a perspective view of the other side in a state in which a tank and a refrigerant pipe are removed from FIG. 5.

FIG. 7 is a front view of FIG. 5.

FIG. 8 is a side view of FIG. 5.

FIG. 9 is a plan view of FIG. 5.

FIG. 10 is a diagram illustrating a state in which a side plate is removed from FIG. 4.

FIG. 11 is a diagram for describing an arrangement of internal components exposed to the outside through a side hole in a case having a different size from FIG. 10.

### DETAILED DESCRIPTION OF THE EMBODIMENTS

Advantages and features of the present disclosure, and methods for accomplishing the same will be more clearly understood from embodiments described in detail below with reference to the accompanying drawings. However, the present disclosure is not limited to embodiments disclosed below but may be implemented in various different forms. However, the embodiments are provided to make the present disclosure be complete and completely announce the scope of the present disclosure to those skilled in the art to which the present disclosure belongs and the present disclosure is just defined by the scope of the claims. The present disclosure is just defined by the scope of the claims. Throughout this specification, the same reference numerals denote the same elements.

Hereinafter, the present disclosure will be described with reference to drawings for describing an air conditioner according to embodiments of the present disclosure.

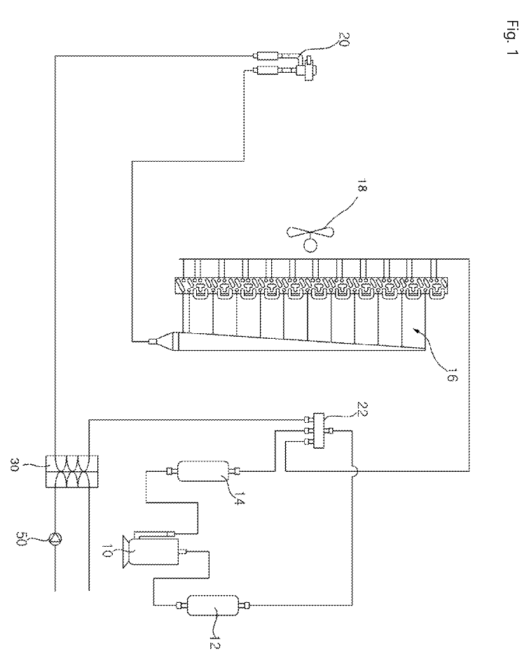

Referring to FIG. 1, a configuration of the air conditioner according to the present disclosure is described.

The air conditioner according to the present disclosure may include a configuration of an outdoor unit disposed on an outdoor side of a building.

The air conditioner includes a compressor 10 that compresses refrigerant.

The air conditioner may include an oil separator 12 that separates oil from refrigerant discharged from the compressor 10.

The air conditioner may include an accumulator 14 that separates oil from refrigerant flowing into the compressor 10. The accumulator 14 may separate gaseous refrigerant from liquid refrigerant and supply the gaseous refrigerant to the compressor 10.

The air conditioner includes a first heat exchanger 16 that exchanges heat between air and refrigerant. The air conditioner includes a fan 18 disposed on one side of the first heat exchanger 16 and forming an air flow to the first heat exchanger 16.

The air conditioner includes a second heat exchanger 30 that exchanges heat between the refrigerant and a heat medium. Here, the second heat exchanger 30 may exchange heat between the refrigerant and water.

The second heat exchanger 30 may be a plate-type heat exchanger that exchanges heat between two different fluids.

The air conditioner includes an expansion valve 20 disposed between the first heat exchanger 16 and the second heat exchanger 30.

The air conditioner includes a switching valve 22 that sends the refrigerant discharged from the compressor 10 to the first heat exchanger 16 or the second heat exchanger 30.

The air conditioner includes a pump device 50 that forms a flow of the heat medium to the second heat exchanger 30.

The pump device 50 may be disposed on one side of the second heat exchanger 30 and may supply the heat medium to the second heat exchanger 30.

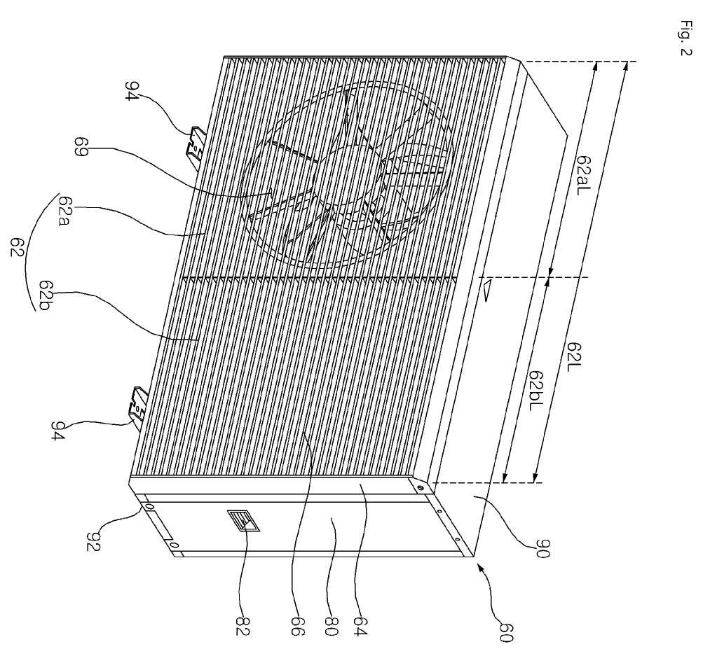

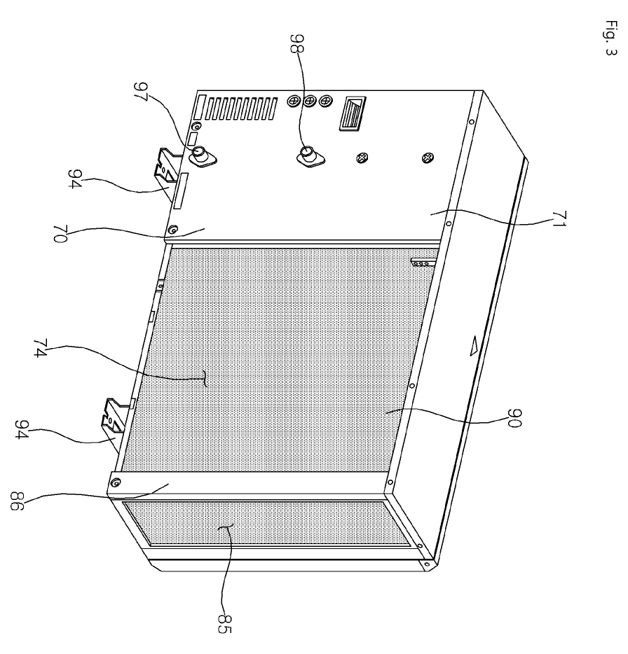

An exterior of the air conditioner according to an embodiment of the present disclosure will be described with reference to FIGS. 2 and 3.

The air conditioner according to the present disclosure includes a case 60 having an inlet 69 and an outlet 74.

The case 60 includes a front cover 62 having the inlet 69 and a rear cover 70 having the outlet 74.

The case 60 includes a side plate 80 connecting one side of the front cover 62 and one side of the rear cover 70.

The case 60 includes a side frame 84 in which a side outlet 85 is formed in an opposite direction to the side plate 80.

The case 60 includes a base 92 and an upper cover 90 forming an upper surface.

The air conditioner may include a support 94 which is disposed below the base 92 and spaces the base 92 upward from a ground surface. The support 94 is disposed as a pair spaced apart from each other in a horizontal direction.

The inlet 69 is formed in the front cover 62. Referring to FIG. 2, a circular inlet 69 is formed in the front cover 62. A fan 18 is disposed in a region where the inlet 69 is formed.

The front cover 62 includes a first front cover 62a forming the inlet 69, and a second front cover 62b disposed at a left side or a right side of the first front cover 62a. The second front cover 62b may be separated from the first front cover 62a.

When the second front cover 62b is separated from the first front cover 62a, the compressor 10 disposed inside the case 60 may be exposed to the outside.

A length 62bL of the second front cover 62b formed in the left-right direction is formed to be equal to or smaller than a length 62aL of the first front cover 62a formed in the left-right direction.

The length 62aL of the first front cover 62a formed in the left-right direction may be formed with a size of 1/3 to 1/2 of a left-right-direction length 62L of an entirety of the front cover 62.

The fan 18 is disposed at a rear of the inlet 69 formed in the first front cover 62a.

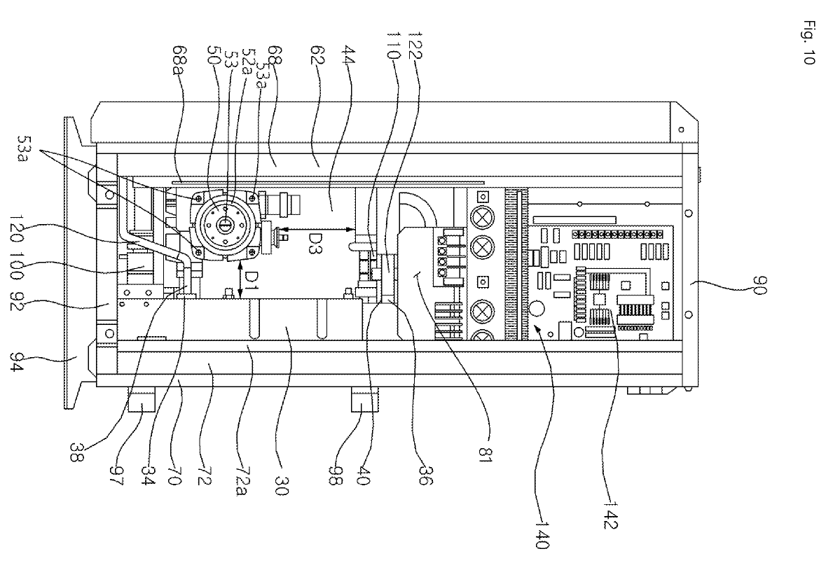

The compressor 10 and the second heat exchanger 30 are disposed at a rear of the second front cover 62b. The pump device 50 is disposed at the rear of the second front cover 62b. A control box 140 (see FIG. 10) in which electrical components for controlling the fan 18 or the compressor 10 are disposed is disposed at the rear of the second front cover 62b.

The front cover 62 includes a front edge wall 64 protruding forward from an outer periphery of the front cover 62. A plurality of grilles 66 which are spaced from each other in an up-down direction are disposed at a front of the front cover 62. The plurality of grilles 66 are disposed inside the front edge wall 64.

The rear cover 70 is disposed at an opposite side to the front cover 62. The outlet 74 is formed on one side of the rear cover 70. A rear panel 71 is disposed on the other side of the rear cover 70.

Connection ports 97 and 98 connected to heat medium pipes 100 and 110 are disposed in the rear panel 71.

The case 60 has an outlet on one side of each of a rear surface and a side surface. The inlet 69 is formed on a front surface of the case 60.

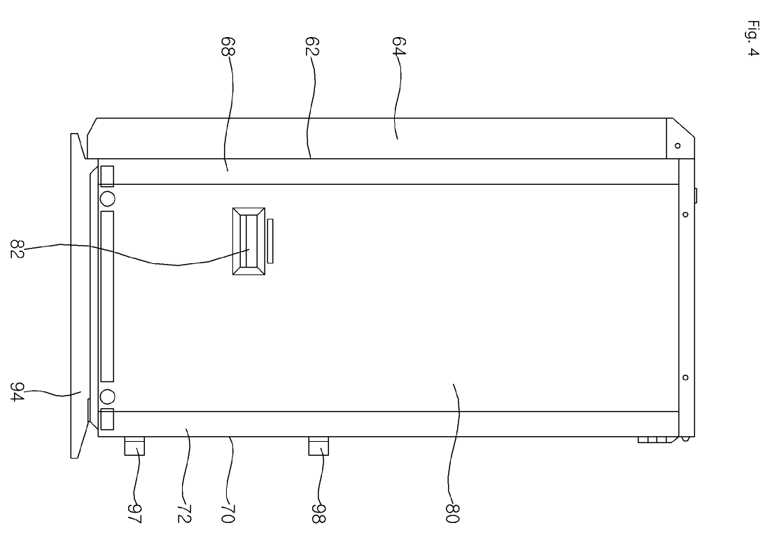

Referring to FIG. 4, a side configuration of the air conditioner according to an embodiment of the present disclosure will be described.

The side plate 80 is disposed between the front cover 62 and the rear cover 70. A grip 82 may be disposed in the side plate 80.

The front cover 62 includes a front cover flange 68 which is bent and protrudes rearward.

The rear cover 70 includes a rear cover flange 72 which is bent and protrudes forward.

The side plate 80 is disposed between the front cover flange 68 and the rear cover flange 72.

The side plate 80 may be fastened to the base 92 or the upper cover 90 by separate fastening means. The side plate 80 may be separated from the front cover 62 or the rear cover 70.

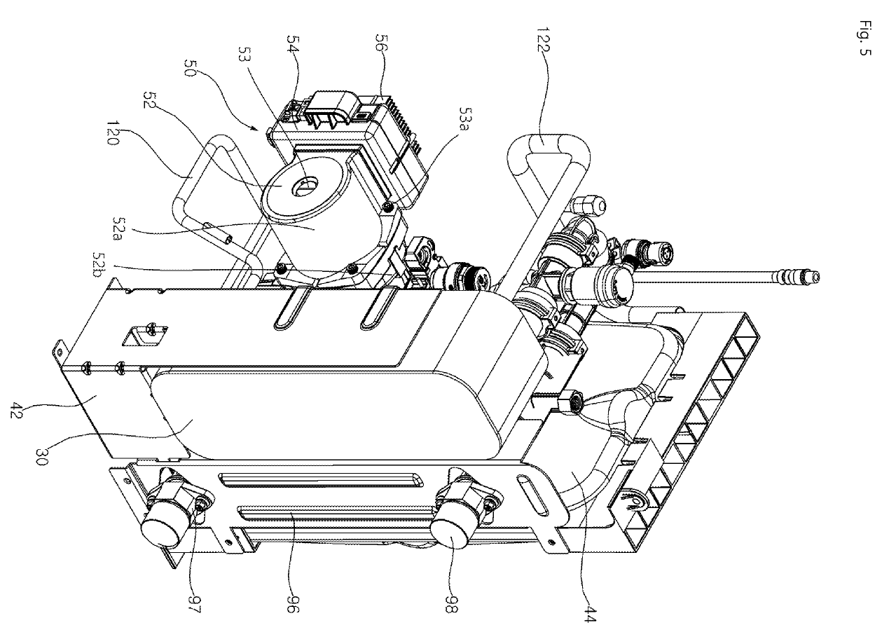

Referring to FIG. 5, the second heat exchanger disposed inside the case and components related thereto will be described.

The second heat exchanger 30 adopts the plate-type heat exchanger. Two refrigerant pipes 120 and 122 and two heat medium pipes 100 and 110 are connected to the second heat exchanger 30.

The second heat exchanger 30 is fixedly disposed inside the case 60 by a heat exchanger frame 42. The heat exchanger frame 42 is connected to a lower portion or a side surface of the second heat exchanger 30. The heat exchanger frame 42 may be fixedly disposed in the base 92.

The pump device 50 supplying the heat medium to the second heat exchanger 30 may be disposed on one side of the second heat exchanger 30.

The second heat exchanger 30 includes a port supporter 96 which fixes the arrangement of the connection ports 97 and 98 of the heat exchange media 100 and 110 on one side thereof. The port supporter 96 is coupled to the rear cover 70.

The port supporter 96 includes a first connection port 97 connected to a first heat medium pipe 100 and a second connection port 98 connected to a second heat medium pipe 110.

The first connection port 97 is disposed below the second connection port 98.

Two refrigerant pipes 120 and 122 are connected to the second heat exchanger 30. A first refrigerant pipe 120 and a second refrigerant pipe 122 are connected to the second heat exchanger 30. The first refrigerant pipe 120 is disposed below the second refrigerant pipe 122.

The first refrigerant pipe 120 may be a liquid pipe connected to the first heat exchanger 16. The second refrigerant pipe 122 may be a gas pipe extending toward the compressor 10.

The pump device 50 is disposed on one side of the first heat medium pipe 100. The pump device 50 may include a pump housing 52, an impeller (not illustrated) disposed inside the pump housing 52, a pump motor (not illustrated) that rotates the impeller, and a motor shaft that connects a pump motor and the impeller.

The pump housing 52 includes a first housing 52a in which the pump motor is disposed and a second housing 52b in which the impeller is disposed. The first housing 52a and the second housing 52b are fastened to each other through a separate bolt 53a. A slot 53 is disposed in the first housing 52a. A flow path in which a fluid flows is formed inside the second housing 52b. An inlet and an outlet through which the heat medium flows in or out are formed on one side of the second housing 52b.

The pump device 50 includes a pump controller 54 that is disposed on one side of the pump housing 52 and operates the pump motor (not illustrated). The pump device 50 includes a pump heat dissipation pin 56 disposed on one side of the pump controller 54.

The pump controller 54 is disposed on one side of the first housing 52a.

A tank 44 is disposed on one side of the second heat exchanger 30, which stores the heat medium. The port supporter 96 is disposed between the second heat exchanger 30 and the tank 44. The tank 44 is connected to the pump device 50.

Therefore, the heat medium flowing through the pump device 50 may flow to the tank 44, or the heat medium stored in the tank 44 may flow to the second heat exchanger 30 through the pump device 50.

Although not illustrated in the drawings, the compressor 10 (see FIG. 1) may be disposed in a second direction of the tank 44. The compressor 10 is disposed in an opposite direction to the second heat exchanger 30 based on the tank 44.

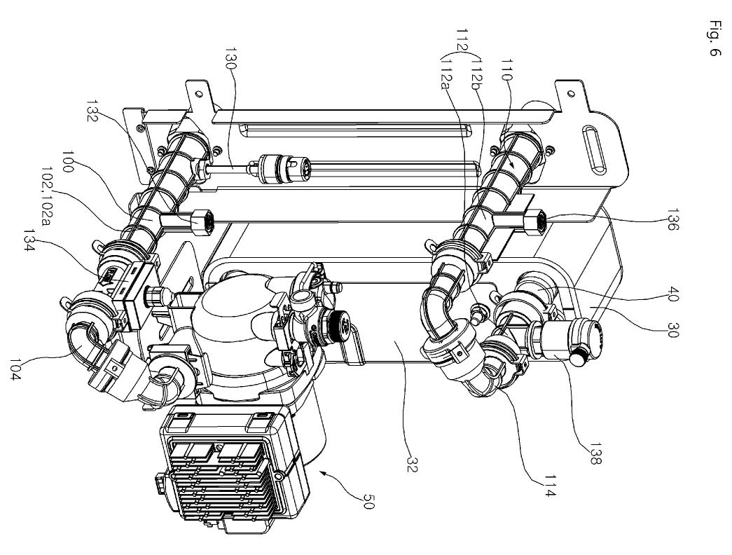

Referring to FIG. 6, a structure and an arrangement of the heat medium pipe connected to the second heat exchanger will be described.

The second heat exchanger 30 includes a front plate 32 to which the heat medium pipes 100 and 110 and the refrigerant pipes 120 and 122 are connected.

Heat medium pipe ports 38 and 40 connected to the heat medium pipes 100 and 110 and refrigerant pipe ports 34 and 36 connected to the refrigerant pipes 120 and 122 are disposed on the front plate 32.

Two heat medium pipes 100 and 110 are connected to the second heat exchanger 30.

A first heat medium pipe 100 in which the pump device 50 is disposed and a second heat medium pipe 110 disposed above the first heat medium pipe 100 are connected to the second heat exchanger 30.

The first heat medium pipe 100 and the second heat medium pipe 110 may be formed by coupling a plurality of pipe bundles.

The plurality of pipe bundles may be manufactured by an injection molding scheme. The plurality of pipe bundles may be made of the same material. The plurality of pipe bundles may be made of a material having heat resistance and excellent mechanical strength.

As one example, the plurality of pipe bundles may be made of a plastic material. As one example, the plurality of pipe bundles may be made of a polyamide material.

Each of the plurality of pipe bundles is formed in a structure in which its ends are coupled to each other.

The plurality of pipe bundles include at least one straight pipe bundle 102 and 112 and at least one curved pipe bundle 104 and 114.

The first heat medium pipe 100 and the second heat medium pipe 110 each protrude forward from the second heat exchanger 30 and extend rearward by changing a direction by 180 degrees.

The first heat medium pipe 100 and the second heat medium pipe 110 each include at least two curved pipe bundles. The pump device 50 is connected to the second heat exchanger 30 by a straight pipe bundle.

The first heat medium pipe 100 includes a plurality of first straight pipe bundles 102 and a plurality of first curved pipe bundles 104. The second heat medium pipe 110 includes a plurality of first straight pipe bundles 102 and a plurality of second curved pipe bundles 114.

The heat medium flowing through the heat medium pipe has a flow direction changed by 180 degrees while passing through the curved pipe bundles.

The plurality of first straight pipe bundles 102 include a first upper straight pipe bundle 102a connected to the second heat exchanger 30 and a first lower straight pipe bundle 102b disposed below the first upper straight pipe bundle 102a.

The first upper straight pipe bundle 102a connects the second heat exchanger 30 and the first curved pipe bundle 104. The first lower straight pipe bundle 102b connects the first curved pipe bundle 104 and the first connection port 97.

The plurality of second straight pipe bundles 112 include a second upper straight pipe bundle 112a connected to the second heat exchanger 30 and a second lower straight pipe bundle 112b disposed below the second upper straight pipe bundle 112a.

The second upper straight pipe bundle 112a connects the second heat exchanger 30 and the second curved pipe bundle 114. The second lower straight pipe bundle 112b connects the second curved pipe bundle 114 and the second connection port 98.

The pump device 50 is disposed in the first heat medium pipe 100.

A water pressure sensor 130 is disposed in the first heat medium pipe 100. A first temperature sensor 132 is disposed in the first heat medium pipe 100. The water pressure sensor 130 and the first temperature sensor 132 are disposed in the first straight pipe bundle 102.

A flow sensor 134 is disposed in the first heat medium pipe 100. The flow sensor 134 is disposed in the first straight pipe bundle 102.

The water pressure sensor 130, the first temperature sensor 132, and the flow sensor 134 are disposed at positions spaced apart from the second heat exchanger 30 in the left-right direction. The pump device 50 is disposed at a position spaced apart from the second heat exchanger 30 forward.

A second temperature sensor 136 is disposed in the second heat medium pipe 110.

An air vent 138 is disposed in the second heat medium pipe 110. The air vent 138 is disposed closer to the second heat exchanger 30 than the second temperature sensor 136.

The second temperature sensor 136 is disposed at a position spaced apart from the second heat exchanger 30 in the left-right direction. The air vent 138 is disposed at a position spaced apart from the second heat exchanger 30 forward.

In the first heat medium pipe 100, the heat medium flows to the second heat exchanger 30 through the pump device 50. In the second heat medium pipe 110, the heat medium discharged from the second heat exchanger 30 flows.

The first heat medium pipe 100 is disposed below the second heat medium pipe 110.

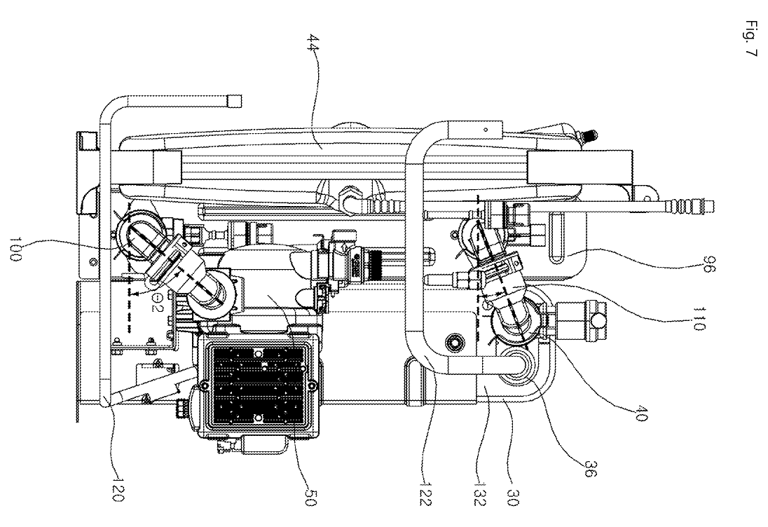

Referring to FIG. 7, the arrangement of the heat exchanger and the heat medium pipes is described.

The heat medium pipe ports 38 and 40 and the refrigerant pipe ports 34 and 36 are disposed on the front plate 32 of the second heat exchanger 30.

A first heat medium pipe port 38 connected to the first heat medium pipe 100 and a second heat medium pipe port 40 connected to the second heat medium pipe 110 are disposed on the front plate 32. The first heat medium pipe port 38 is disposed below the second heat medium pipe port 40.

A first refrigerant pipe port 34 connected to the first refrigerant pipe 120 and a second refrigerant pipe port 36 connected to the second refrigerant pipe 122 are disposed on the front plate 32. The first refrigerant pipe port 34 is disposed below the second refrigerant pipe port 36.

The second heat medium pipe port 40 is disposed on one side of the second refrigerant pipe port 36 in the left-right direction. The first heat medium pipe port 38 is disposed on one side of the first refrigerant pipe port 34 in the left-right direction.

The second heat medium pipe port 40 is disposed in a first direction of the second refrigerant pipe port 36. The first heat medium pipe port 38 is disposed in a first direction of the first refrigerant pipe port 34.

Here, the first direction may be a direction perpendicular to an up-down direction and perpendicular to a front-rear direction.

Here, the first direction may be a direction in which the side plate 80 is disposed when viewed based on a case. A second direction may be a direction opposite to the first direction.

The heat medium pipe ports 38 and 40 are disposed closer to the tank 44 side than the refrigerant pipe ports 34 and 36.

The first heat medium pipe 100 is disposed below the second heat medium pipe 110.

A distance at which the first heat medium pipe port 38 and the first refrigerant pipe port 34 are spaced apart in the left-right direction is formed to be larger than a distance at which the second heat medium pipe port 40 and the second refrigerant pipe port 36 are spaced apart in the left-right direction.

Pipe diameters of the first refrigerant pipe 120 and the second refrigerant pipe 122 are formed to be smaller than pipe diameters of the first heat medium pipe 100 and the second heat medium pipe 110.

The first refrigerant pipe 120 and the second refrigerant pipe 122 are disposed to be spaced apart from the tank 44 than the first heat medium pipe 100 and the second heat medium pipe 110, respectively.

The first heat medium pipe 100 and the second heat medium pipe 110 are disposed in a space between the second heat exchanger 30 and the tank 44. The first heat medium pipe 100 and the second heat medium pipe 110 extend to the space between the second heat exchanger 30 and the tank 44.

The first lower straight pipe bundle 102b is disposed between the tank 44 and the second heat exchanger 30. The second lower straight pipe bundle 112b is disposed between the tank 44 and the second heat exchanger 30. A port supporter 96 in which the first connection port 97 and the second connection port 98 are disposed is disposed between the second heat exchanger 30 and the tank 44.

The first curved pipe bundle 104 of the first heat medium pipe 100 is disposed to be inclined downward. The second curved pipe bundle 114 of the second heat medium pipe 110 is disposed to be inclined downward.

The first curved pipe bundle 104 of the first heat medium pipe 100 is disposed to be inclined more downward than the second curved pipe bundle 114 of the second heat medium pipe 110.

An angle θ1 at which the first curved pipe bundle 104 of the first heat medium pipe 100 is inclined downward is formed to be greater than an angle θ2 at which the second curved pipe bundle 114 of the second heat medium pipe 110 is inclined downward.

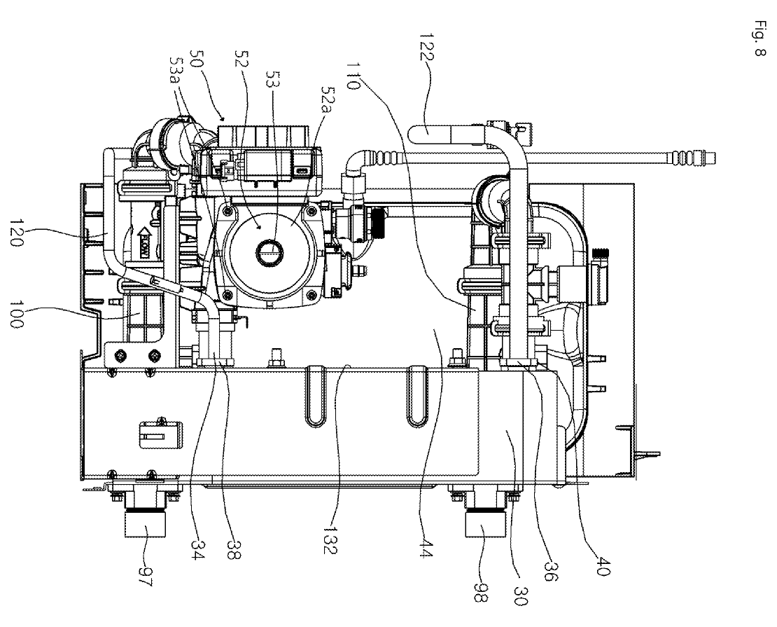

Referring to FIG. 8, an arrangement of the second heat exchanger and the pump device in another direction will be described.

The front plate 32 of the second heat exchanger 30 is disposed to face forward. The front plate 32 of the second heat exchanger 30 is disposed to face the pump device 50 disposed at the front.

The front plate 32 of the second heat exchanger 30 is disposed to be spaced apart from the pump device 50. The pump device 50 includes a pump housing 52 and a pump controller 54 disposed on one side of the pump housing 52. The pump controller 54 is disposed at a front of the pump housing 52.

The pump housing 52 includes a slot 53. The slot 53 is disposed on one side surface of the pump housing 52. The slot 53 may be rotated by a driver, etc. When the slot 53 is rotated, a motor shaft (not illustrated) connected to a pump motor (not illustrated) and an impeller (not illustrated) may be rotated. The motor shaft (not illustrated) may be a rotating shaft connecting the pump motor and the impeller (not illustrated).

The slot 53 is formed in a first housing 52a.

When the pump device 50 is operated for a long time, the impeller (not illustrated) or the pump motor (not illustrated) may become stuck due to accumulation of sediments, etc., inside the pump housing 52.

In this case, the slot 53 may be rotated to resolve a stuck phenomenon of the impeller or motor shaft.

A plurality of bolts 53a are disposed in the first housing 52a. The plurality of bolts 53a couple the first housing 52a and the second housing 52b. The slot 53 disposed in the first housing 52a is disposed to face laterally. The plurality of bolts 53a disposed in the first housing 52a is disposed to face laterally.

A pump heat dissipation pin 56 is disposed at a front of the pump controller 54.

The second heat medium pipe 110 is disposed spaced apart upward from the pump device 50.

The first refrigerant pipe 120 and the second refrigerant pipe 122 are disposed in the first direction of the first heat medium pipe 100 and the second heat medium pipe 110. Accordingly, when viewed in a direction illustrated in FIG. 8, the first heat medium pipe 100 and the second heat medium pipe 110 may be partially covered by the first refrigerant pipe 120 and the second refrigerant pipe 122.

However, the pipe diameters of the first refrigerant pipe 120 and the second refrigerant pipe 122 are formed to be smaller than the pipe diameters of the first heat medium pipe 100 and the second heat medium pipe 110, respectively, so it is possible to approach the first heat medium pipe 100 and the second heat medium pipe 110.

The first refrigerant pipe 120 and the second refrigerant pipe 122 include at least one bending region.

The first refrigerant pipe 120 includes an additional bending region to secure an arrangement space for the pump device 50.

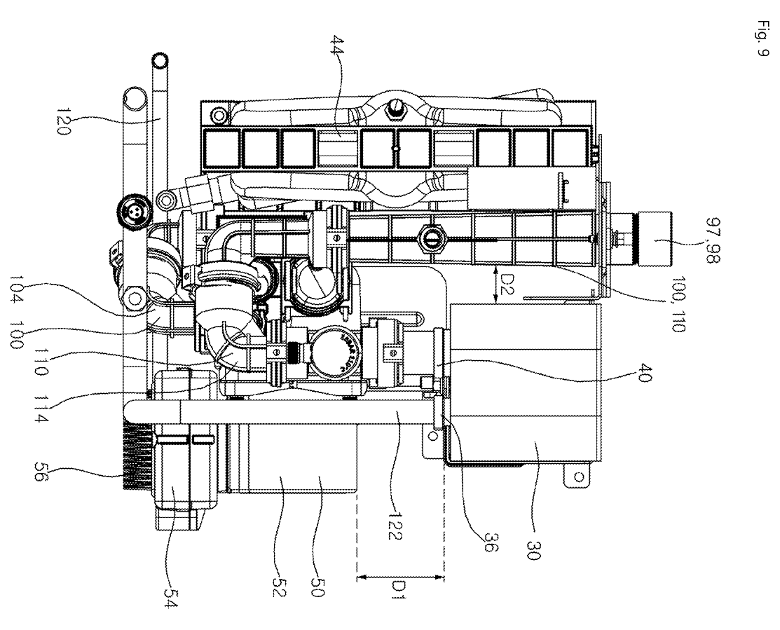

Referring to FIG. 9, the arrangement of the second heat exchanger, the pump, and the heat medium pipes will be described.

When viewed from the top, the connection ports 97 and 98 and the second heat exchanger 30 are spaced apart from each other in the left-right direction.

When viewed from the top, the heat medium pipes 100 and 110 connected to the connection ports 97 and 98 and the second heat exchanger 30 are spaced apart from each other in the left-right direction. When viewed from the top, the heat medium pipes 100 and 110 connected to the connection ports 97 and 98 are disposed between the second heat exchanger 30 and the tank 44.

A distance D1 at which the pump device 50 and the second heat exchanger 30 are spaced apart in the front-rear direction is formed to be larger than a distance D3 at which the second heat exchanger 30 and the heat medium pipes 100 and 110 are spaced apart in the left-right direction.

Referring to FIG. 10, an internal structure of an air conditioner with a side plate removed according to an embodiment of the present disclosure will be described.

A side hole 81 is formed between the front cover 62 and the rear cover 70. When the side plate 80 is removed, the side hole 81 is opened.

When the side plate 80 is removed, the second heat exchanger 30 and the control box 140 may be exposed to the outside. The control box 140 is disposed above the second heat exchanger 30.

A plurality of electronic components are disposed in the control box 140. A circuit board 142 that operates the compressor 10 or the fan 18 is disposed in the control box 140.

Therefore, only the side plate 80 is removed to repair and inspect an interior of the control box 140.

When the side plate 80 is removed, the second heat exchanger 30 and the pump device 50 are exposed to the outside. The pump device 50 is disposed at the front of the second heat exchanger 30.

When the side plate 80 is removed, the heat medium pipes 100 and 110 are exposed.

When the side plate 80 is removed, the first heat medium pipe 100 and the second heat medium pipe 110 are connected to the second heat exchanger 30 are exposed. Further, a plurality of sensors connected to the first heat medium pipe 100 and the second heat medium pipe 110 may be exposed through the side hole 81. The plurality of sensors may include the water pressure sensor 130, the temperature sensors 132 and 136, and the flow sensor 134 described through FIG. 6.

The pump device 50 may be disposed in the first heat medium pipe 100. The second heat medium pipe 110 is disposed spaced apart upward from the pump device 50.

A distance D3 at which the second heat medium pipe 110 is spaced apart upward from the pump device 50 may be formed to be larger than the distance D1 at which the pump device 50 is spaced apart forward from the second heat exchanger 30.

When the side plate 80 is removed, a part of the tank 44 may be exposed.

When the side plate 80 is removed, a front surface of the second heat exchanger 30 is exposed. The second heat exchanger 30 is disposed adjacent to the rear cover 70. Accordingly, the front surface of the second heat exchanger 30 is disposed to face forward. When the side plate 80 is removed, the refrigerant pipe ports 34 and 36 are the heat medium pipe ports 38 and 40 disposed on the front plate of the second heat exchanger 30 are exposed.

An interior of the case 60 includes a tank 44 connected to the pump device 50 and storing a portion of the heat medium. When the side plate 80 is removed, a part of the tank 44 is exposed to the outside.

A left-right width 30w of the second heat exchanger 30 may be formed to be equal to or less than 1/3 of a left-right width 60w of the case 60.

When the side plate 80 is removed, a front cover tip 68a protruding rearward from the front cover flange 68 is exposed. The front cover tip 68a is spaced apart from the front cover flange 68 in a second direction.

When the side plate 80 is removed, a rear cover tip 72a protruding forward from the rear cover flange 72 is exposed. The rear cover tip 72a is spaced apart from the rear cover flange 72 in the second direction.

The slot 53 of the pump housing 52 is exposed to the outside. In the first housing 52a, a surface on which the slot 53 is formed is disposed to face a direction in which the side plate 80 is disposed. Accordingly, when the side plate 80 is removed, the slot 53 formed in the first housing 52a is exposed to the outside.

Further, when the side plate 80 is removed, the plurality of bolts 53a disposed in the first housing 52a are exposed to the outside. Therefore, when the side plate 80 is removed, the slot 53 of the pump housing 52 may be rotated or the bolt 53a may be removed. That is, a service may be provided according to a problem which occurs in the pump device 50.

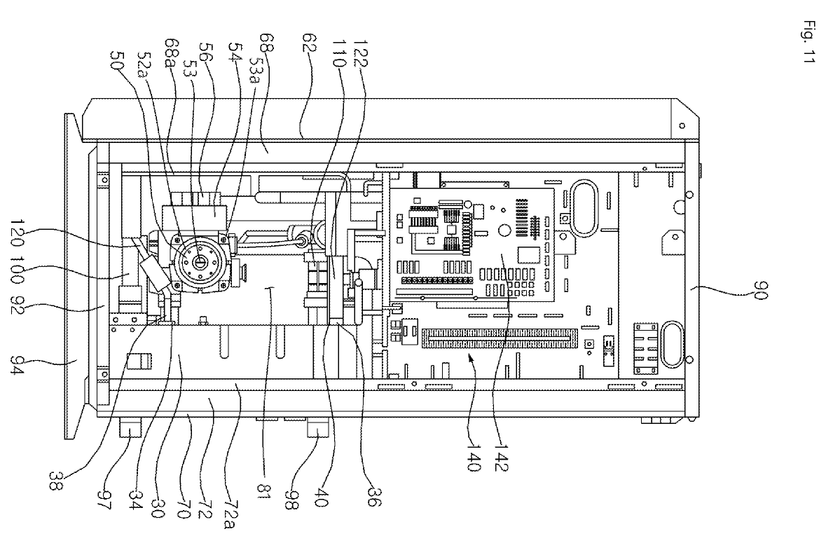

Referring to FIG. 11, an internal structure of an air conditioner with a side plate removed according to another embodiment of the present disclosure will be described.

The air conditioner according to FIG. 11 differs from the air conditioner illustrated in FIG. 10 in a size of the case. Therefore, the second heat exchanger 30 illustrated in FIG. 11 is formed to have a size relatively smaller than the size of the case 60.

Further, a size of a space occupied by the control box 140 is formed differently. Further, an arrangement of a printed circuit board 142 disposed inside the control box 140 may be formed differently.

A size of the side hole 81 formed in the case 60 according to FIG. 11 may be increased. Therefore, an area where the pump device 50 is exposed through the side hole 81 may be increased.

In the air conditioner according to FIG. 11, the second heat exchanger 30 is also disposed at a front of the rear cover 70.

When the side plate 80 is removed, the refrigerant pipe ports 34 and 36 are the heat medium pipe ports 38 and 40 disposed on the front plate of the second heat exchanger 30 are exposed. When the side plate 80 is removed, the heat medium pipes 100 and 110 are exposed though the side hole 81.

When the side plate 80 is removed, the tank 44 is exposed though the side hole 81.

The pump device 50 is disposed at the front of the second heat exchanger 30.

The first heat medium pipe 100 and the second heat medium pipe 110 are connected to the second heat exchanger 30.

The first heat medium pipe 100 and the second heat medium pipe 110 are bent and extend rearward. The first heat medium pipe 100 and the second heat medium pipe 110 are connected to the first connection port 97 and the second connection port 98, respectively, which are disposed on the rear cover 70.

The pump controller 54 and the pump heat dissipation pin 56 of the pump device 50 are disposed to be exposed through the side hole 81.

When the side plate 80 is removed, the slot 53 formed in the first housing 52a is exposed to the outside. When the side plate 80 is removed, the plurality of bolts 53a disposed in the first housing 52a are exposed to the outside.

While the preferred embodiments of the present disclosure have been illustrated and described above, the present disclosure is not limited to the aforementioned specific embodiments, various modifications may be made by a person with ordinary skill in the technical field to which the present disclosure pertains without departing from the subject matters of the present disclosure that are claimed in the claims, and these modifications should not be appreciated individually from the technical spirit or prospect of the present disclosure.

What is claimed is:

1. A heat supplier comprising:
a case including:
a front cover including an inlet;
a rear cover including an outlet; and
a side plate covering a side hole located between the front cover and the rear cover;
a second heat exchanger disposed inside the case and configured to exchange heat between a refrigerant and a heat medium, the second heat exchanger being exposed to an outside when the side hole is opened; and
a control box disposed inside the case, the control box being exposed to the outside when the side hole is opened.

2. The heat supplier of claim 1, wherein the control box is disposed above the second heat exchanger.

3. The heat supplier of claim 1, further comprising a pump device disposed inside the case and configured to supply the heat medium to the second heat exchanger,
wherein, when the side hole is opened, the pump device is exposed to the outside.

4. The heat supplier of claim 3, wherein the pump device includes a pump housing,
wherein a slot is located on one side of the pump housing, and
wherein, when the side hole is opened, the slot is exposed to the outside.

5. The heat supplier of claim 4, wherein the pump housing includes:
a first housing; and
a second housing located adjacent to the first housing such that the first housing and second housing overlap in a horizontal direction of the heat supplier,
wherein the first housing and the second housing are fastened to each other by a bolt, and
wherein, when the side hole is opened, the bolt is exposed to the outside.

6. The heat supplier of claim 3, wherein the pump device is disposed spaced apart in a forward direction from the second heat exchanger.

7. The heat supplier of claim 3, wherein the second heat exchanger includes a front plate in which a plurality of ports are disposed, the front plate being connected to a refrigerant pipe and a heat medium pipe through the plurality of ports, and
wherein the front plate is disposed spaced apart in a rear direction from the pump device.

8. The heat supplier of claim 1, further comprising:
a refrigerant pipe; and
a heat medium pipe,
wherein the second heat exchanger includes a front plate on which a refrigerant pipe port to which the refrigerant pipe is connected and a heat medium pipe port to which the heat medium pipe is connected are disposed, and
wherein the refrigerant pipe port is disposed closer to the side hole than the heat medium pipe port.

9. The heat supplier of claim 8, wherein the refrigerant pipe includes a smaller diameter than a diameter of the heat medium pipe.

10. The heat supplier of claim 1, further comprising:
a heat medium pipe connected to the second heat exchanger, and through which the heat medium is configured to flow,
wherein the heat medium pipe comprises a plurality of pipe bundles, the plurality of pipe bundles each including a same material, and
wherein at least one end of each of the plurality of pipe bundles are coupled to ends of other respective pipe bundles of the plurality of pipe bundles.

11. The heat supplier of claim 1, comprising:
a first heat medium pipe connected to the second heat exchanger and configured to supply the heat medium to the second heat exchanger; and
a second heat medium pipe connected to the second heat exchanger and configured to discharge the heat medium from the second heat exchanger,
wherein the first heat medium pipe is disposed below the second heat medium pipe, and
wherein a pump device is disposed in the first heat medium pipe.

12. The heat supplier of claim 11, wherein the pump device is disposed spaced apart in a forward direction from the second heat exchanger,
wherein the second heat medium pipe is disposed spaced apart in an upward direction from the pump device, and
wherein a distance at which the second heat medium pipe is spaced in the upward direction from the pump device is larger than a distance at which the pump device is spaced in the forward direction from the second heat exchanger.

13. The heat supplier of claim 11, wherein the first heat medium pipe and the second heat medium pipe each include a straight pipe bundle and a curved pipe bundle, and
wherein the curved pipe bundle is configured to change a flow direction of the heat medium to an opposite direction.

14. The heat supplier of claim 13, further comprising a sensor disposed in a straight pipe bundle, the sensor being configured to sense a temperature or pressure of the heat medium flowing through the first heat medium pipe or the second heat medium pipe.

15. The heat supplier of claim 11, wherein the first heat medium pipe includes a first straight pipe bundle and a first curved pipe bundle,
wherein the second heat medium pipe includes a second straight pipe bundle and a second curved pipe bundle,
wherein the first curved pipe bundle and the second curved pipe bundle are each disposed to be inclined downward, and
wherein an inclination angle of the first curved pipe bundle is greater than an inclination angle of the second curved pipe bundle.

16. The heat supplier of claim 1, wherein a width of the second heat exchanger in a left-right direction is equal to or less than 1/3 of a width of the case in the left-right direction.

17. The heat supplier of claim 1, further comprising:
a tank disposed inside the case and configured to store a portion of the heat medium that flows through the second heat exchanger; and
a connection port disposed on one side of the case and connected to a heat medium pipe extending from the second heat exchanger,
wherein the second heat exchanger is disposed closer to the side hole than the tank, and
wherein the connection port is disposed between the tank and the second heat exchanger.

18. The heat supplier of claim 1, further comprising:
a first heat exchanger;
a tank disposed inside the case and configured to store a portion of the heat medium that flows through the second heat exchanger; and
a compressor configured to compress refrigerant, and transfer the compressed refrigerant to the first heat exchanger, the first heat exchanger being configured to exchange heat with the compressed refrigerant with air or the second heat exchanger,
wherein the compressor is disposed on a first side of the tank and the second heat exchanger is disposed on a second side of the tank opposite to the first side.

19. The heat supplier of claim 18, wherein the front cover further includes:
a first front cover including the inlet; and
a second front cover disposed on one side of the first front cover and configured to be separated from the first front cover, and
wherein, when the second front cover is separated from the first front cover, the compressor is exposed to the outside.

20. The heat supplier of claim 1, wherein the control box includes a plurality of electrical components disposed inside the control box, and
wherein, when the side hole is opened, the plurality of electrical components disposed in the control box is exposed to the outside.
